(19) United States
(12) Patent Application Publication
(10) Pub. No.: US 2003/0144935 A1
(43) Pub. Date: Jul. 31, 2003

(54) Methods and systems for processing, accounting, and administration of stored value cards

(76) Inventor: Michael F. Sobek, Leawood, KS (US)

Correspondence Address: John S. Beulick, Armstrong Teasdale LLP, One Metropolitan Sq., Suite 2600, St. Louis, MO, 63102, US

(21) Appl. No.: 10/354,776

(22) Filed: Jan. 30, 2003

Related U.S. Application Data
(60) Provisional application No. 60/352,960, filed on Jan. 30, 2002.

(51) Int. Cl. G06F 17/60

(52) U.S. Cl. 705/35

(57) ABSTRACT

Methods are described for accounting, administration and processing of transactions utilizing a stored value card utilizing an EFT service gateway and providing balances for the cards across a plurality of point of sale devices. One method includes receiving an ISO 8583 formatted message generated by the point of sale system of a merchant and parsing the message into data elements. The method also includes validating a merchant ID exists within the merchant database assigned to the issued card, routing the message through a switch controller to an account holder database based on an institution ID and a branch ID, accessing an account within the database utilizing the account key, and determining if an account holder's monetary balance in the account is greater than or equal to the transaction amount. An ISO-8583 compatible message is formatted and one of an authorization approval or a denial based upon the determination is transmitted.

### CROSS REFERENCE TO RELATED APPLICATIONS

This application claims the benefit of U.S. Provisional Application No. 60/352,960, filed Jan. 30, 2002.

### BACKGROUND OF THE INVENTION

This invention relates generally to the facilitating of transactions, and more specifically to systems and methods for facilitating the issue of stored value, gift cards and the account management, processing, and settlement of transactions by banks, credit unions, or third party processors. The consumer acceptance of stored value cards, such as monetary gift cards issued by retail merchants to consumers, has proliferated in recent years. Transactions which take place utilizing these cards have been conducted utilizing proprietary, closed networks operated within the point of sale systems deployed by the said merchant and electronic funds transfer networks.

Banks and credit unions have not participated in the issue of stored value cards since products, services, and system gateways typically do not exist between their core accounting systems and proprietary merchant point of sale systems. Given the growth of the stored-value card industry, banks and credit unions have investigated different means to offer these plastic card based services.

Real estate developers who own retail shopping malls have also expressed a desire to participate in offering monetary, stored-value cards to consumers as a replacement for paper gift certificates currently purchased by consumers. Paper gift certificates typically are printed with a bank routing and transit number that enables the certificate to be cashed or deposited by any merchant or financial institution both within, and outside of, the mall. In addition, for those consumer transactions completed with amounts lower than face value limit of the certificate, the mall merchant must return cash to the consumer versus additional products or services.

Both shopping malls and merchants within the geography of the mall desire certificates to be replaced with private label, monetary, stored value, gift cards. These gift cards must be issued by a bank or credit union and operate seamlessly across a variety of merchant point of sale machines using the existing debit and credit card networks, such as VISA, MasterCard, American Express, and Discover, typically connected to the existing merchant point of sale machines. The gift card transactions must be limited to merchants within the boundaries defined by the shopping mall or developer who manages multiple malls.

Typically, holders of these stored value, gift cards are anonymous in nature. That is, if a card is lost, the finder of the card is able to utilize any remaining funds on the card as if it was his own.

Another problem with the anonymity is that a card holder has difficulty in determining a balance of the stored value remaining on the card. Either the user has to manually track the stored value remaining on the card, or some processors, typically those associated with shopping malls, deploy specialized card reading machines which provide a balance remaining to the user when the card is scanned. However, when the user attempts to utilize the stored value card for a transaction within the shopping mall, for example at a restaurant or a clothing store, and has not previously determined the remaining value on the card, the transaction may be denied for lack of monetary value on the card.

The problem is that the individual establishments within the mall typically only have access to one electronic funds transfer system through a point-of-sale (POS) terminal, and the stored value cards are not completely compatible with these electronic fund transfer systems and terminals. The problem for the shopper is that when the transaction is denied, the shopper is only notified of the denial, and is not provided with balance data. In a real world example, if the shopper is attempting to make a $35.00 purchase with a stored value card which has $25.00 of stored value, he or she is typically unable to complete the transaction utilizing $ 10.00 of cash or perhaps a credit or debit card to make up the difference as a split-tender.

Another desire of merchants and developers is to enable stored-value, gift cards to be reloaded upon the depletion of the funds available through the card. The process of reloading the cards with additional monetary funds must be completed through various mediums such as client terminals located at mall customer service desks, through Internet web services, or through ISO 8583 debit card transactions credit funds to the account of the card holder. In addition, merchants desire loyalty programs to be delivered in association with the reloading of the gift card where merchant monetary dividends would be posted into the account of the card holder. The anticipated result is loyalty created between merchants and consumers and monetary compensation is passed back to the consumer in reward of this merchant loyalty.

### BRIEF SUMMARY OF THE INVENTION

In one aspect, a method for completing a stored value card transaction utilizing a gateway into a national, ISO 8583 electronic funds transfer service is provided. The method comprises receiving at the gateway an ISO 8583 formatted message originally generated by the point of sale system of a retail merchant, parsing the message into a series of data elements representing at least a transaction amount, a transaction type, a merchant ID, a bank identification number, an institution ID, a branch ID, and an account identifier, and validating the merchant ID exists within the merchant database assigned to the issued card. The method further comprises routing the message through a switch controller to an account holder database based on the institution ID and the branch ID, accessing an account within the database utilizing the account key, determining if an account holder's monetary balance in the account is greater than or equal to the transaction amount, formatting transaction data, the transaction data including at least a transaction amount, a bank ID number, an institution ID, a branch ID, and an account key, into an ISO-8583 compatible message, and transmitting one of an authorization approval or a denial based upon the determination.

In another aspect, an accounting system for regional malls, operators of malls and developers is provided. The accounting system comprises a database and file system which includes at least one of anonymous and known consumer account data and a plurality of retail merchant and mall office workstations running client applications networked over LANs and secure WANs. The system also comprises a secure Internet banking gateway that receives inquiries from at least one of consumers utilizing at least one of the Internet, a telephone system, and point of sale terminals, card dispensing machines, and the retail merchant and mall office workstations, and the consumers and workstations requesting account balances and transaction history to be delivered via web services. The system also comprises a telephone gateway that receives inquiries from at least one of consumers and the retail merchant and mall office workstations requesting account balances and transaction histories, the inquiries being answered utilizing stored voice recordings. The system further comprises an electronic funds transfer (EFT) gateway networked into one or more ISO 8583 electronic funds transfer services, at least one funds settlement gateway into at least one of the Federal Reserve ACH network and corporate credit union automated settlement network, and a messaging and switch controller used to simultaneously route stored value card transactions and client initiated transactions from at least one of said gateways.

### BRIEF DESCRIPTION OF THE DRAWINGS

FIG. 1 is a block diagram of a core network of financial transaction systems.

FIG. 2 is a diagram of the system of FIG. 1 with an additional stored value card databases, gateways, and settlement systems.

FIG. 3 is a flowchart of a transaction processing method performed by the system of FIG. 2.

FIG. 4 is an example numbering plan for a stored value card system.

FIG. 5 illustrates one embodiment of a settlement process.

FIG. 6 illustrates a process for completing balance inquiries utilizing the system shown in FIG. 2.

### DETAILED DESCRIPTION OF THE INVENTION

A variety of stored value card platforms is described that are offered by banking institutions and credit unions to merchants, retail center owners, and consumers that result from the integration of banking and credit union accounting practices, systems and services, national and international settlement and electronic transaction networks. Anonymous gift card services, enabled by stored value cards and offered by merchants, mall operators and developers, are enabled by the mapping and switching of transactions that historically have not crossed business boundaries of the diverse, highly regulated, financial industries and regional merchants or mall developers. Several diverse industry standards are mapped together via computer software programs and electronic switching and transaction networks to perform the necessary accounting system interfaces between the diverse industry groups.

In one embodiment, a typical banking or credit union system architecture is applied to the needs of the shopping mall operators and developers. The bank accounting system must adhere to the practices and use of customizable parameter files that allow a mall or developer to set key variables such as fee thresholds and assign periods of time before a card holder account becomes dormant. The banking system also provides a hierarchical numbering plan that will enable a developer to issue cards to one or many malls and complete daily balancing procedures for each mall or across all malls as necessary.

All the products and services offered by the financial services industry are enabled for the anonymous card holder via the mall accounting system. In essence, the mall performs the financial services consistent with the bank.

One significant benefit of the banking system is the inherent tracking of dormant accounts that is required for the gift card service offered by malls. Consistent with state escheatment laws, malls and developers are allowed to charge service fees against dormant accounts after a period of time normally ranging from six to eighteen months. These fees may be charged until the card expires or the balance on the card is reduced to zero.

Managing the account balances including historical transactions for current as well as dormant accounts is a key feature of the accounting system deployed for malls and developers.

Sophisticated bank or credit union systems maintain online transaction gateways with the national electronic funds transfer (EFT) networks that conform to the ISO 8583 international standard enabling card services such as debit, ATM, and point of sale services to be delivered to the consumer. This national standard has been implemented across a variety of merchant point of sale systems allowing a seamless transfer of purchasing transactions to be passed across national and international EFT networks linking merchants, banks and credit unions across the globe.

In a similar solution, malls performing as card issuers use the ISO 8583 gateway to carry stored value card transactions to accounting databases representing the card holder accounts.

Using the dividend calculation and accounting structure established for bank and credit union customers, gift card issuers deploy a merchant loyalty program that is based upon a pre-approved percentage of the sale (e.g. 10%) to be paid as a dividend to the card holder account as a reward to their demonstrated loyalty and business brought to the participating merchant. For banks and credit unions, these dividend programs exist today and are typically calculated each month or quarter for savings, CD's and Individual retirement accounts.

Funds settlement between the mall gift card issuer, banks, credit unions and national EFT networks is completed for stored-value cards using proven operational systems. Transfers between financial institutions are, at least in part, handled utilizing an automated clearinghouse network (ACH). The ACH Network is a batch processing, store-and-forward system. Transactions received by the financial institution during the day are stored and processed later in a batch mode. Rather than sending each payment separately, ACH transactions are accumulated and sorted by destination for transmission during a predetermined time period. This provides significant economies of scale. It also provides faster processing than paper checks, which must be physically handled. Instead of using paper to carry necessary transaction information, ACH transactions are transmitted electronically between financial institutions through data transmission. Typically, five participants are involved in an ACH transaction: the originating company or individual (Originator), the Originating Depository Financial Institution (ODFI), the ACH Operator, the Receiving Depository Financial Institution (RDFI), and the receiving company, employee or customer (Receiver).

The Originator is an entity that agrees to initiate ACH entries into the payment system according to an arrangement with a Receiver. The Originator is usually a company directing a transfer of funds to or from a consumer's or another company's account. In the case of a Customer Initiated Entry (CIE), the Originator may be an individual initiating funds transfer activity from his or her own account. The term “company” is intended to represent the Originator of electronic ACH entries and does not imply exclusion of other types of organizations (i.e., Federal, state and local government agencies). An Originator may be either a company or a consumer.

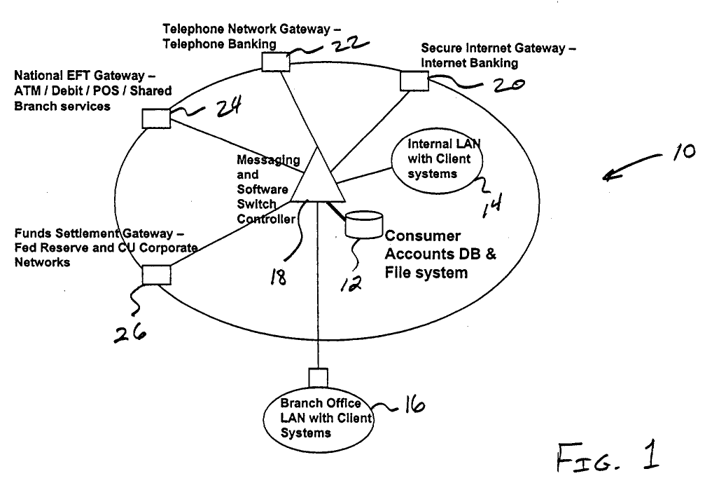

From a system architecture perspective, FIG. 1 illustrates a core network of financial transaction processing systems 10 typically combined to offer a suite of financial services, including funds transfer and electronic banking transactions, to banking customers and members of credit unions. Processing system 10 includes a relational database and electronic file system 12 of consumer and business accounts that contain information about every account holder associated with the bank or credit union. In one embodiment, database 12 includes name and address information, a variety of financial accounts such as checking, savings, loans, and investments such as certificate of deposit and investment retirement accounts. Database 12 typically resides on secure computer servers (not shown) with highly redundant components to maintain the integrity of the account holder files.

Database 12 is accessed by clients through file servers utilizing PC workstations 14, which are logically combined by a LAN or remotely linked to branch offices 16 by a WAN. Utilizing workstations 14, clients create transaction messages that initiate the primary financial services of deposit, withdrawal, account transfer, inquiry, and file maintenance for their accounts residing in database 12.

The clients transactions are routed by a software messaging and switch controller 18 that in one embodiment utilizes TCP/IP socket communications to establish logical network connections between the clients and servers to transfer data and complete core accounting functions.

Both manual and automated clients drive a variety of transactions against account holder database and file system 12. These may include electronic clients residing in gateways into the Internet 20, public telephone systems 22, national Electronic Funds Transfer (EFT) networks (ATM, Point of Sale, Debit Card, and Shared Branch) 24, and national funds settlement networks operated by the Federal Reserve and Corporate Credit Union system 26.

Each of these different gateways operate utilizing message formats that have been standardized across the industry or using proprietary formats that have been created by vendors who deliver products in support of the banking and credit union industries. Often, the gateways into the various networks described above complete a mapping of transactions into a common format that allows the primary financial services of deposit, withdrawal, account transfer, inquiry, and file maintenance to be completed seamlessly across system 10.

System 10 also provides functions such as administration and management reporting, settlement, statement generation, financial projections, interest calculations, amortization, and overall general ledger functions required to manage the bank and credit union as required by federal regulations.

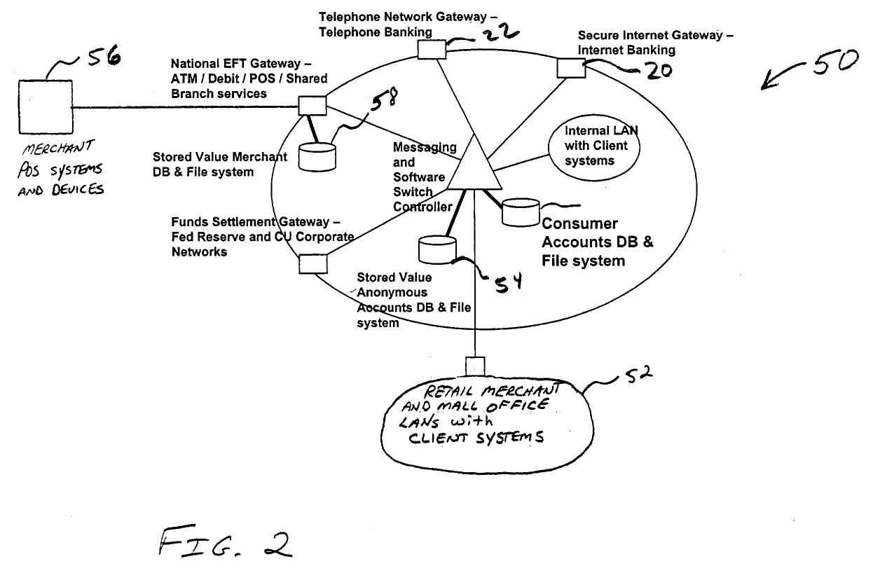

FIG. 2 illustrates the enhancements required for the bank or credit union platform that enable the system of FIG. 1 to be customized for malls and developers who offer stored-value, gift card services. Referring to FIG. 2, system 50 includes an accounting system with client systems 52 for regional malls, operators of malls and developers that includes a database and file system 54 which includes both anonymous and known consumer account data. These databases may be accessed via workstations (not shown) located at the retail merchant and mall office and networked over LANs and secure WANs.

A client application is deployed at the client system 52 and this application enables cards to be issued at the mall customer service desk using tools such as a magnetic card swipe reader to populate and match the cards with preloaded accounts at the consumer 12 and anonymous account databases 54.

The mall or developer network is dependent upon access through the national EFT networks operated by VISA, MasterCard, Discover, and American Express, or regional operators such as FDR, STAR, and PLUS to access the point of sale systems and devices 56 at participating merchant offices. These devices and systems utilize the ISO 8583 standard protocol when generating and receiving transactions during the purchase and authorization processes.

Other components include a stored-value, merchant database and filing system 58 that is assigned to each of the cards issued by malls or developers. Transactions are validated against this database during the process of transaction authorization.

A secure Internet banking gateway 20 is deployed that receives inquiries from at least one of consumers utilizing at least one of the Internet, a telephone system, and point of sale terminals, card dispensing machines, and said retail merchant and mall office workstations, the consumers and workstations requesting account balances and transaction history to be delivered via web services.

A telephone gateway 22 is deployed that receives inquiries from at least one of consumers and said retail merchant and mall office workstations requesting account balances and transaction histories, the inquiries being answered utilizing stored voice recordings.

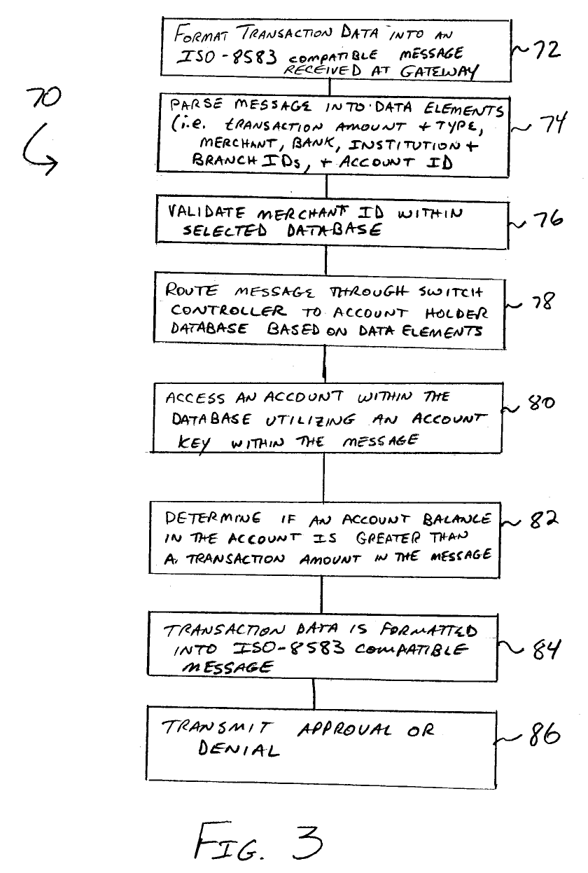

FIG. 3 is a flowchart 70 of the transaction processing method of the flowchart performed by the system of FIG. 2. In one embodiment, the method is for completing a stored value card transaction utilizing the above described gateway into a national, ISO 8583 electronic funds transfer service. Referring specifically to FIG. 3, an ISO 8583 formatted message originally generated by the point of sale system of a retail merchant is received 72 at the gateway. The received 72 message is parsed 74 into a series of data elements representing at least, but not limited to, a transaction amount, a transaction type, a merchant ID, a bank identification number, an institution ID, a branch ID, and an account identifier. The merchant ID is validated 76 to ensure the ID exists within the merchant database assigned to the issued stored value card.

The message is routed 78 through a switch controller to an account holder database based on the institution ID and the branch ID and an account is accessed 80 within the database utilizing the account key. It is determined 82 whether an account holder's monetary balance in the account is greater than or equal to the transaction amount. Transaction data, which includes at least a transaction amount, a bank ID number, an institution ID, a branch ID, and an account identifier, is formatted 84 into an ISO-8583 compatible message and one of an authorization approval or a denial, based upon the determination, is transmitted 86.

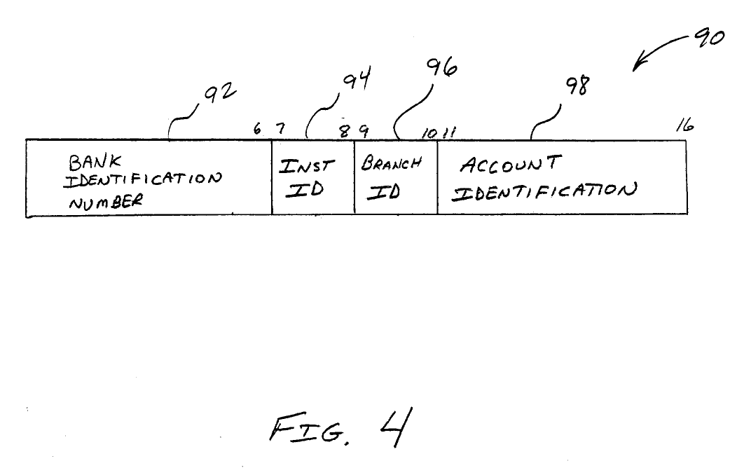

FIG. 4 is an example numbering plan for a stored value card system. At least a portion of transaction data is included in a stored value card account number, as illustrated in FIG. 4. In one embodiment, an account number 90 for the card is a 16 character string. Specifically, and in one embodiment, a six character field is defined as a bank identification number 92, a two character field is defined as an institution ID 94, which, for example, identify a developer or an owner of several malls or shopping centers for the stored value card. A branch ID 96 is a two character identifier for which particular mall or shopping center of the developer from which the card is or is to be issued. A six character account identifier 98 is utilized to identify individual stored value cards.

In one embodiment, when utilizing the stored value card, the ISO-8583 formatted message that is generated includes a transaction code which signifies that the desired transaction is at least one of a deposit, a withdrawal, a transfer, and a balance inquiry.

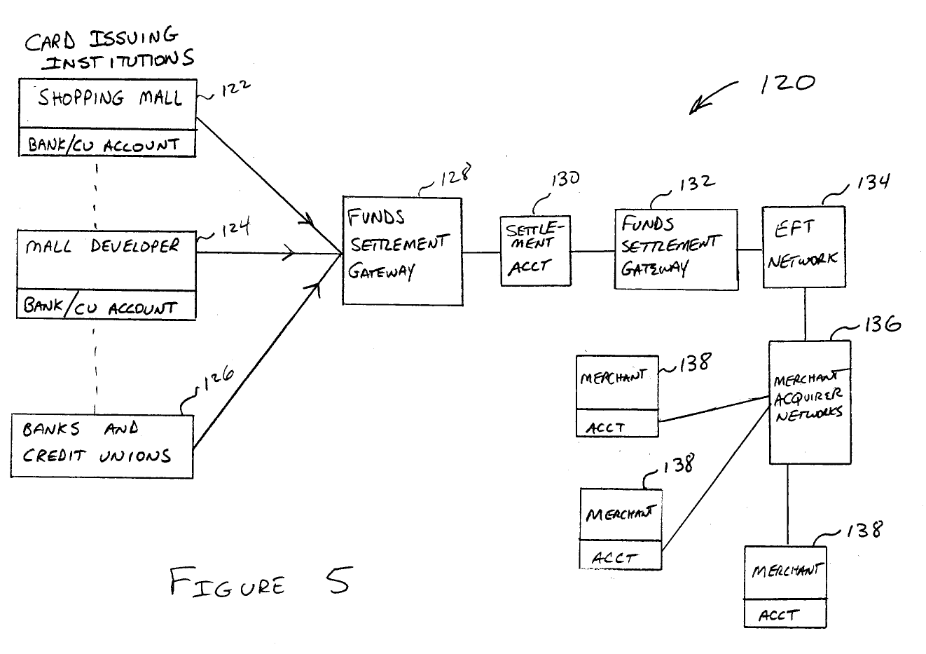

FIG. 5 diagrams a settlement process 120 for issuance and usage of stored value cards utilizing system 50 as above described. Referring specifically to FIG. 5 card issuing institutions, for example, shopping malls 122, mall developers 124 and banks and credit unions 126 provide transaction data to a funds settlement gateway 128, for example, via a secure data network connection. The transaction data is utilized to credit or debit a settlement account 130. The funds from settlement account 130 are, in one embodiment, wired to a second funds settlement gateway 132 which provides access to an electronic funds transfer network 134. Electronic funds transfer network 134 provides a transfer of the funds to merchant acquirer networks 136, which are configured to credit and debit, as the individual cases may be, accounts of individual merchants 138, for example.

In one embodiment, at least some of the funds transfer files are compatible with the Federal Reserve banking system file formats and at least some of the funds transfer files are compatible with Corporate Credit Union automated settlement network file formats. Funds equal to the total within each funds transfer file transferred to settlement account 130 as described above utilizing known distribution methods.

In one embodiment, for a balance inquiry, a balance inquiry message is created when the account holders' monetary balance is less than a point of sale transaction amount. An ISO 8583 response code for declining the authorization request is selected, and an alpha-numeric string containing the current account balance and text message describing the reason for declining the transaction is created.

The response code and alpha-numeric string is formatted into an ISO 8583 compatible message and an authorization denial is transmitted to the gateway where it is routed to the originating merchant point of sale device. Finally, a text message is displayed at the point of sale which indicates the denial, but also provides an available balance on the stored value card which, for example, the merchant can provide to the holder of the stored value card.

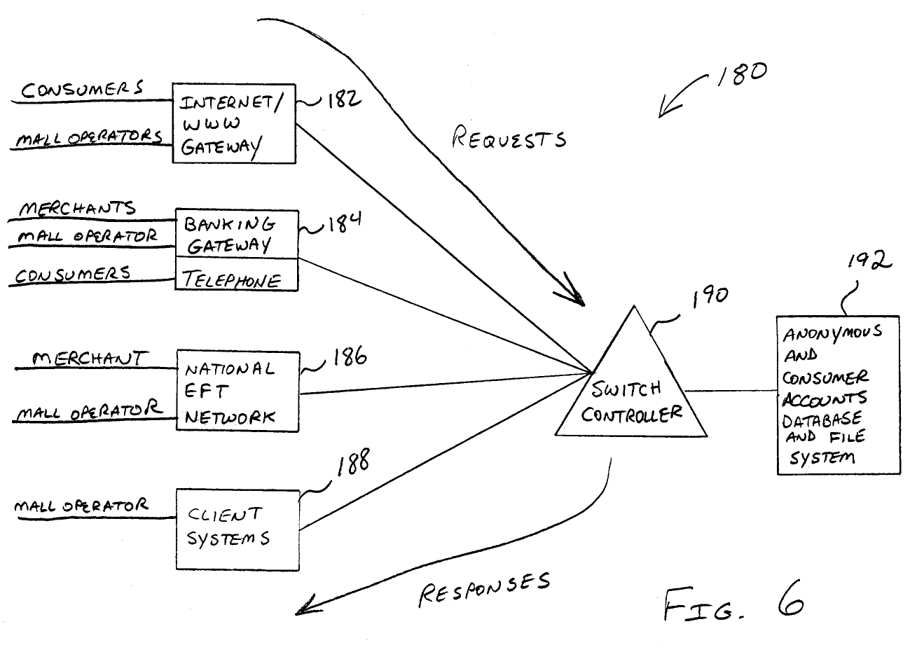

FIG. 6 diagrams a process 180 for balance inquiries utilizing the system of FIG. 2. In one embodiment, consumers and mall operators utilize internet gateways 182 to initiate and receive results of balance inquiries, A banking gateway 184 is utilized by one or more of merchants, mall operators, and consumers, typically through telephone banking, for balance inquiries. Certain merchants and mall operators can access national electronic funds network 186 for balance inquiry operations. Other mall operators utilize client systems 188 which provide a mechanism for balance inquiries. All inquiries are routed to switch controller 190, which as described above, can access an anonymous and consumer accounts database and file system 192. Upon receipt of the individual account balance being inquired, switch controller 192 provides a response to the requester, which includes approval or denial and the account balance information that can be supplied to the card user as described above.

The above described methods and systems build upon existing bank and credit union funds transfer and accounting systems to add new services related to the, processing, accounting and administration of stored value cards, particularly by providing messaging capability to provide account balance data. The described systems accomplish these functionalities by merging features of a proprietary, software switching and mapping system with gateways into the client server applications typical of accounting systems that deliver banking services to consumers. The result is the delivery of an improved stored value card services to consumers, merchants and card issuers. In addition, the above described methods and systems allow and enable banks and credit unions to merge issuance of stored value cards with their existing credit and debit card infrastructures.

The above described systems provide processing methods which further supports multiple electronic funds transfers, internet and telephone access, and banking network access by linking into a core processing center. In one embodiment, the stored value card program utilizes a private-label, bank issued card and national telecommunications networks to simplify integration and operation with existing, merchant point of sales (POS) systems. Retailers accept the gift card like a credit card and consumers can purchase items from the mall merchants up to the amounts credited to the card during activation. Upon using the available funds on the card, consumers can reload their account with additional funds via the customer service center in the mall or the Internet. Consumers purchase their cards from the mall's customer service desk or ATM dispensing machines conveniently located in or near the mall. Shoppers can make inquiries about their card balances via merchant point of sale terminals, toll-free telephone numbers, and Internet websites.

While the invention has been described in terms of various specific embodiments, those skilled in the art will recognize that the invention can be practiced with modification within the spirit and scope of the claims.

What is claimed is:

1. A method for completing a stored value card transaction utilizing a gateway into a national, ISO 8583 electronic funds transfer service, said method comprising:
receiving at the gateway an ISO 8583 formatted message originally generated by the point of sale system of a retail merchant;
parsing the message into a series of data elements representing at least a transaction amount, a transaction type, a merchant ID, a bank identification number, an institution ID, a branch ID, and an account identifier;
validating the merchant ID exists within the merchant database assigned to the issued card;
routing the message through a switch controller to an account holder database based on the institution ID and the branch ID;
accessing an account within the database utilizing the account key;
determining if an account holder's monetary balance in the account is greater than or equal to the transaction amount; and
formatting transaction data, the transaction data including at least a transaction amount, a bank ID number, an institution ID, a branch ID, and an account key, into an ISO-8583 compatible message;
transmitting one of an authorization approval or a denial based upon the determination.

2. A method according to claim 1 wherein the ISO-8583 formatted message includes a transaction code for at least one of a deposit, a withdrawal, a transfer, and a balance inquiry.

3. A method according to claim 1 further comprising:
creating a balance inquiry message when the account holders' monetary balance is less than the point of sale transaction amount;
selecting the ISO 8583 response code for declining the authorization request;
creating an alpha-numeric string containing the current account balance and text message describing the reason for declining the transaction;
formatting the response code and alpha-numeric string into an ISO 8583 compatible message;
transmitting the authorization denial to the gateway where it is routed to the originating merchant point of sale device; and
displaying the text message at the point of sale.

4. An accounting system for regional malls, operators of malls and developers comprising:
a database and file system which includes at least one of anonymous and known consumer account data;
a plurality of retail merchant and mall office workstations networked over LANs and secure WANs, said workstations running client applications;
a secure Internet banking gateway that receives inquiries from at least one of consumers utilizing at least one of the Internet, a telephone system, and point of sale terminals, card dispensing machines, and said retail merchant and mall office workstations, the consumers and workstations requesting account balances and transaction history to be delivered via web services;
a telephone gateway that receives inquiries from at least one of consumers and said retail merchant and mall office workstations requesting account balances and transaction histories, the inquiries being answered utilizing stored voice recordings;
an electronic funds transfer (EFT) gateway, said EFT gateway networked into one or more ISO 8583 electronic funds transfer services;
at least one funds settlement gateway into at least one of the Federal Reserve ACH network and corporate credit union automated settlement network; and
a messaging and switch controller used to simultaneously route stored value card transactions and client initiated transactions from at least one of said gateways.
